(19) United States
(12) Patent Application Publication
(10) Pub. No.: US 2014/0314374 A1
(43) Pub. Date: Oct. 23, 2014

(54) GRATING COUPLERS WITH DEEP-GROOVE NON-UNIFORM GRATINGS

(71) Applicants: David A. Fattal, Mountain View, CA (US); Marco Fiorentino, Mountain View, CA (US); Zhen Peng, Foster City, CA (US)

(72) Inventors: David A. Fattal, Mountain View, CA (US); Marco Fiorentino, Mountain View, CA (US); Zhen Peng, Foster City, CA (US)

(21) Appl. No.: 14/345,210

(22) PCT Filed: Oct. 21, 2011
(86) PCT No.: PCT/US2011/057265

§ 371 Date: Mar. 14, 2014

(51) Int. Cl. G02B 6/34; G02B 5/18

(52) U.S. Cl. CPC G02B 6/34; G02B 5/1861
USPC 385/33; 359/575; 385/37

(57) ABSTRACT

Grating couplers that enable efficient coupling between waveguides and optical fibers are disclosed. In one aspect, a grating coupler includes a transition region that includes a wide edge and tapers away from the edge toward a waveguide disposed on a substrate. The coupler also includes a sub-wavelength grating disposed on the substrate adjacent to the edge. The grating is composed of a series of non-uniformly distributed, approximately parallel lines and separated by grooves with a depth to output light from the grating with TM polarization.

### BACKGROUND

In recent years, replacement of electronic components with optical components in high performance computer systems has received considerable attention, because optical communication offers a number of potential high-performance advantages over electronic communication. On the one hand, electronic components can be labor intensive to set up and sending electric signals using conventional wires and pins consumes large amounts of power. In addition, it is becoming increasingly difficult to scale the bandwidth of electronic interconnects, and the amount of time needed to send electric signals using electronic components, such as electronic switches, takes too long to take full advantage of the high-speed performance offered by smaller and faster processors. On the other hand, optical components, such as optical fibers have large bandwidths, provide low transmission loss, enable data to be transmitted with significantly lower power consumption than is needed to transmit the same information encoded in electric signals, are immune to cross talk, and are made of materials that do not undergo corrosion and are not affected by external radiation.

Although, optical communication appears to be an attractive alternative to electronic communication, many existing optical components are not well suited for all types of optical communication. For instance, optical fibers can be used to transmit optical signals between electronic devices, and certain optical components, such as waveguides and microring couplers, are expected to replace or to complement many electronic circuits on a typical CMOS chip. However, one of the key challenges computer manufactures face is efficiently coupling optical signals from a waveguide to an optical fiber. The use of optical components to couple light between a waveguide and an optical fiber is challenging because of the large mode mismatch between the optical fiber and the waveguide. For this and other reasons, computer manufactures seek systems that increase the coupling efficiency of light between waveguides and optical fibers.

### DESCRIPTION OF THE DRAWINGS

FIGS. 1A-1B show an isometric view and a top-plan view, respectively, of an example grating coupler.

FIG. 2 shows an isometric view of an example grating coupler with a cover.

FIG. 3A shows a cross-sectional view of the grating coupler shown in FIG. 2 along a line I-I.

FIG. 3B shows a top-plan view of a transition region and a non-uniform grating of the grating coupler shown in FIG. 2.

FIG. 4 shows a top-plan view of a tapered transition region and a non-uniform grating of an example grating coupler.

FIG. 5 shows a top-plan view of a tapered transition region and a non-uniform grating of an example grating coupler.

FIG. 6 shows a top-plan view of a tapered transition region and a non-uniform grating of an example grating coupler.

FIG. 7 shows a plot of duty cycle versus distance across three types of non-uniform gratings.

FIG. 8 shows a top-plan view of a transition region and a grating and represents TE and TM polarization conventions.

FIG. 9 shows a cross-sectional view of a grating coupler and a butt end of an optical fiber.

FIG. 10 shows a cross-sectional view of a grating coupler and a butt end of an optical fiber capped with a focusing lens.

### DETAILED DESCRIPTION

Grating couplers that enable efficient coupling between waveguides and optical fibers are disclosed. The grating couplers include a deep-grooved, non-uniform, sub-wavelength grating that couples light from a waveguide into the core of an optical fiber with TM polarization. In the following description, the term “light” refers to electromagnetic radiation with wavelengths in the visible and non-visible portions of the electromagnetic spectrum, including infrared and ultra-violet portions of the electromagnetic spectrum.

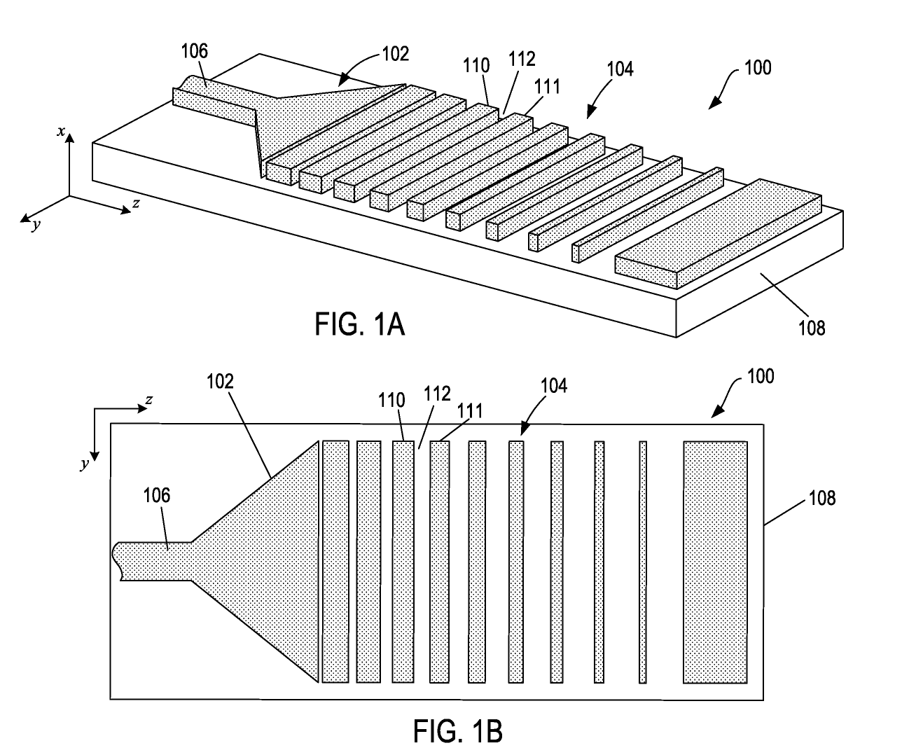

FIGS. 1A-1B show an isometric view and a top-plan view, respectively, of an example grating coupler 100. The grating coupler 100 includes a tapered transition region 102 and a non-uniform, sub-wavelength grating 104. As shown in the example of FIGS. 1A-1B, the transition region 102 has an isosceles triangular-like shape that narrows away from the grating 104 and transitions into a strip waveguide 106. The waveguide 106 can also be a ridge waveguide or a strip loaded waveguide. The transition region 102 and grating 104 are disposed on a planar surface of a substrate 108. The grating 104 is composed of a series of approximately parallel lines, such as lines 110 and 111, separated by grooves, such as groove 112. The term “approximate” is used to describe the relative orientation of the lines, or other quantities described herein, where ideally parallel line orientation is intended but in practice it is recognized that imperfections in measurements or imperfections in the fabrication process cause the relative orientation of the lines or other quantities to vary.

The transition region 102 and the grating 104 are composed of a higher refractive index material than the substrate 108. As a result, the substrate 108 serves as a lower cladding layer for the transition region 102 and the grating 104. In particular, the transition region 102 and the grating 104 can be composed of a single elemental semiconductor, such as silicon (“Si”) or germanium (“Ge”), or the transition region 102 and grating 104 can be composed of a compound semiconductor, such as III-V compound semiconductor, where Roman numerals III and V represent elements in the IIIa and Va columns of the Periodic Table of the Elements. Compound semiconductors can be composed of column IIIa elements, such as aluminum (“Al”), gallium (“Ga”), and indium (“In”), in combination with column Va elements, such as nitrogen (“N”), phosphorus (“P”), arsenic (“As”), and antimony (“Sb”). Compound semiconductors can also be further classified according to the relative quantities of III and V elements. For example, binary semiconductor compounds include semiconductors with empirical formulas GaAs, InP, InAs, and GaP; ternary compound semiconductors include semiconductors with empirical formula GaAs_{y}P_{1-y}, where y ranges from greater than 0 to less than 1; and quaternary compound semiconductors include semiconductors with empirical formula InₓGa₁₋ₓAs_{y}P_{1-y}, where both x and y independently range from greater than 0 to less than 1. Other types of suitable compound semiconductors include II-VI materials, where II and VI represent elements in the IIb and VIa columns of the periodic table. For example, CdSe, ZnSe, ZnS, and ZnO are empirical formulas of exemplary binary II-VI compound semiconductors. The substrate 108 can be composed of lower refractive index material, such as SiO₂ or Al₂O₃. Alternatively, the transition region 102 and grating 104 can be composed of a non-semiconductor material or polymer. For example, the transition region 102 and grating 104 can be composed of titanium (“Ti”) and the substrate 108 can be composed of lithium niobate (“LiNbO₃”).

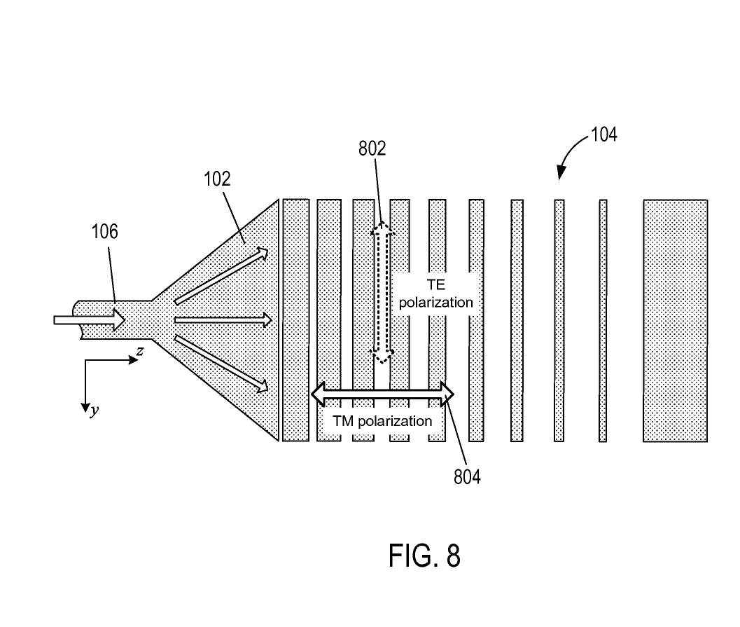

The grating coupler 100 can be formed by first depositing a high refractive index material on a flat surface of a low refractive index material that serves as the substrate 108. The transition region 102 and grating 104 can be formed in the higher refractive index material layer using any one of various lithographic and/or etching techniques, such as nanoimprint lithography or reactive ion etching, to form deep grooves between the lines of the grating 104. The grooves that separate the lines are formed by selectively removing the high refractive index material. In the example of FIGS. 1A-1B, the grating 104 is a deep-groove, high-contrast grating formed by removing the higher refractive index material so that the surface of the substrate 108 is exposed between the lines. In general, groove depth is a substantial fraction of the waveguide height and is selected to ensure a strong scattering of the TM polarization component of the light transmitted into the grating 104, as described below with reference to FIG. 8.

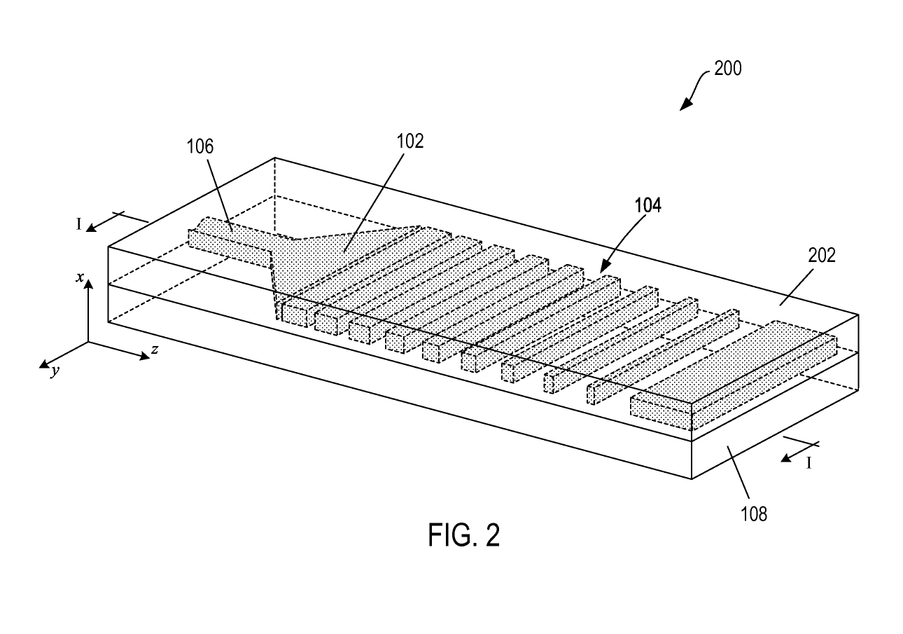

As shown in the example of FIGS. 1A-1B, the grating coupler 100 has an air cladding. In other embodiments, a lower refractive index material, such as the material used to form the substrate 108, can be deposited over the transition region 102 and grating 104 to form a cover that serves as an upper cladding layer. FIG. 2 shows an isometric view of a grating coupler 200. The coupler 200 is similar to the coupler 100 except the coupler 200 includes a cover 202 that covers the transition region 102 and grating 104. The cover 202 is composed of a lower refractive index material than that of the transition region 102 and grating 104, such as SiO₂ or Al₂O₃, and serves as an upper cladding layer for the transition region 102 and grating 104.

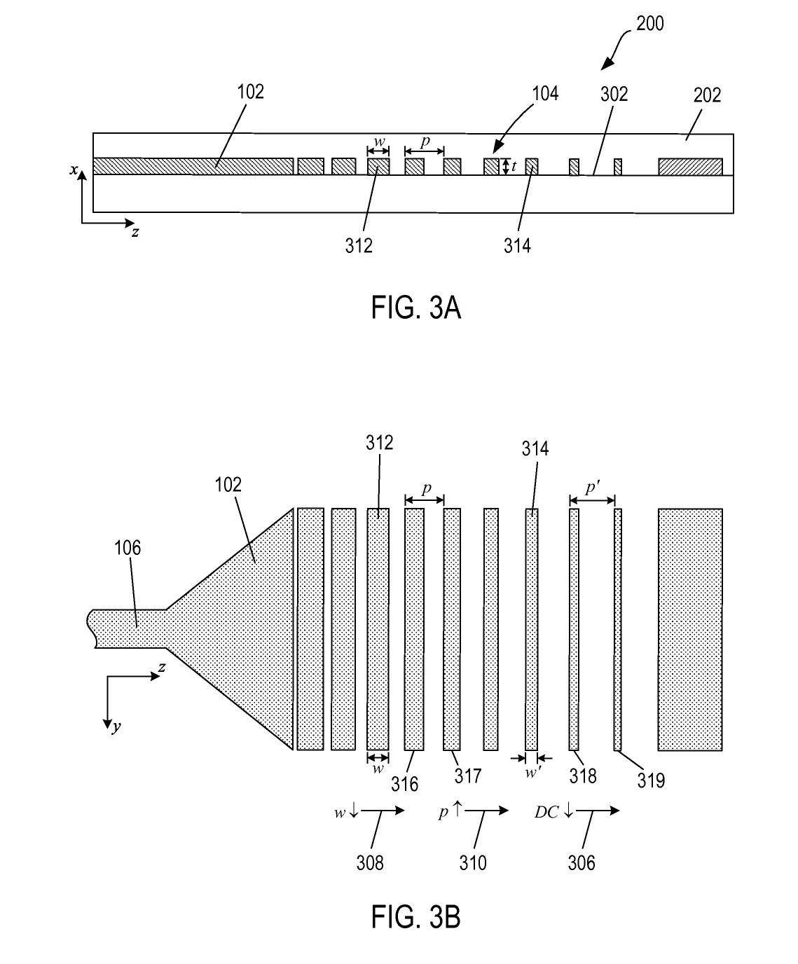

FIGS. 3A-3B show a cross-sectional view of the grating coupler 200 and a top-plan view of the transition region 102 and grating 104, respectively. As shown in FIG. 3A, and in FIGS. 1A and 2, the grating 104 is deep grooved in that the surface 302 of the substrate 102 between the lines is exposed. The grating 104 is referred to as a sub-wavelength grating because the line width, w, lines spacing, p, and line thickness, t, are smaller than the wavelength of the electromagnetic radiation emitted from the grating coupler. The ratio of the line width, w, to the line spacing, p, in the z-direction is characterized by the duty cycle:

$$D C = \frac{w}{p}$$

In the example of FIGS. 3A-3B, directional arrow 306 indicates the direction in which the duty cycle of the grating 104 decreases in the z-direction from the wide edge 304 of the transition region 102. In other words, for the particular example grating 104 represented in FIGS. 3A- 3 B, the line width decreases, w↓, from the edge 304 in the z-direction, as represented by directional arrow 308, and the line spacing p increases, p↑, from the wide edge 304 in the z-direction, as represented by directional arrow 310. For example, line 312 is closer to the edge 304 than line 314 and the width w of the line 312 is greater than the width w′ of the line 314, and a pair of adjacent lines 316 and 317 is closer to the edge 304 than a pair of adjacent lines 318 and 319 with the line spacing p between lines 316 and 317 greater than the line spacing p′ between lines 318 and 319.

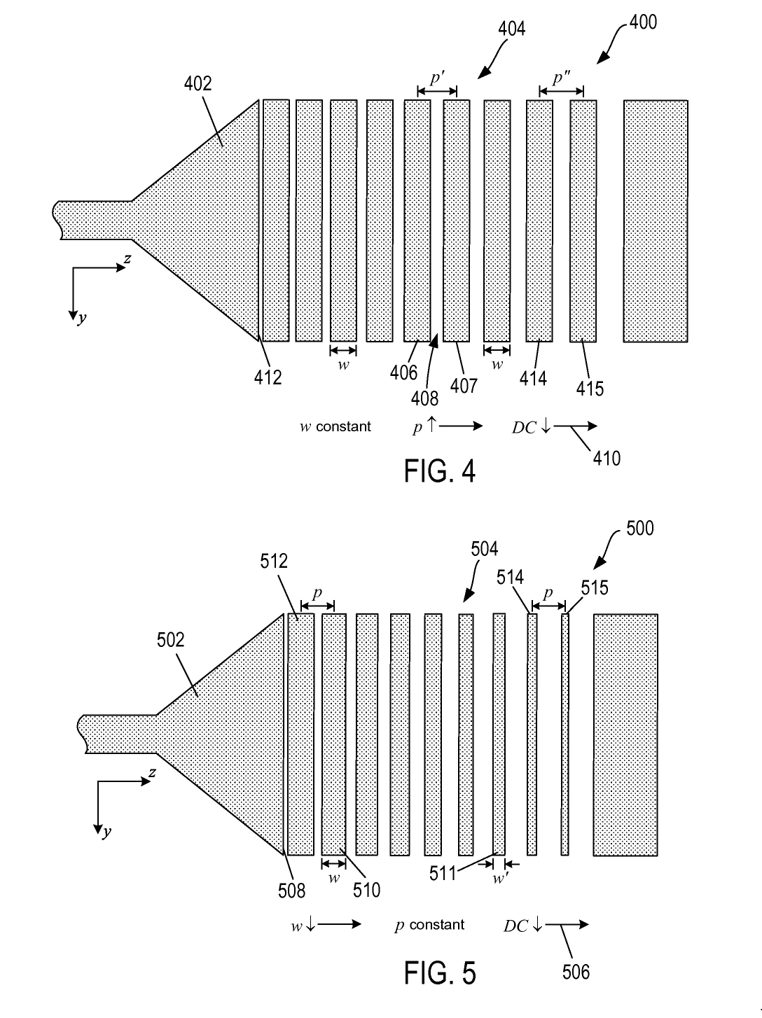

Non-uniform gratings are not intended to be limited to the example grating 104. Other types of suitable gratings in which the duty cycle decreases in the z-direction away from the wide edge of the transition region can be accomplished by fabricating the lines with the same line width while the line spacing is increased in the z-direction. FIG. 4 shows a top-plan view of a tapered transition region 402 and a non-uniform, sub-wavelength grating 404 of an example grating coupler 400. Like the non-uniform grating 104 of the grating couplers 100 and 200, the grating 404 is composed of a series of approximately parallel lines, such as adjacent pair of lines 406 and 407, separated by deep grooves, such as the deep groove 408 located between the lines 406 and 407. The lines have the same line width w throughout, but the line spacing increases away from the wide edge 412 of the transition region 402 in the z-direction resulting in the grating 404 having a duty cycle that decreases in the z-direction. For example, line spacing p′ between the adjacent pair of lines 406 and 407 is greater than line spacing p″ between adjacent pair of lines 414 and 415, which are located farther from the edge 412 than the lines 406 and 407.

Other types of suitable non-uniform gratings in which the duty cycle decreases in the z-direction away from the wide edge of the transition region can be accomplished by fabricating the lines with line widths that decrease in the z-direction while the line spacing is constant throughout. FIG. 5 shows a top-plan view of a tapered transition region 502 and a non-uniform, sub-wavelength grating 504 of an example grating coupler 500. Like the non-uniform gratings 104 and 404, the grating 504 is composed of a series of approximately parallel lines separated by deep grooves that expose the surface of a substrate (not shown). The center-to-center line spacing is held constant throughout the grating 504, but the widths of the lines decrease away from the wide edge 508 in the z-direction, resulting in the grating 504 having a duty cycle that decreases in the z-direction. For example, a line 510 is located closer to the edge 508 than line 511 and the width w of the line 510 is greater than the width w′ of the line 511, but the spacing between adjacent pair of lines 512 and 510 is approximately the same as the spacing between adjacent pair of lines 514 and 515 located farther from the edge 508.

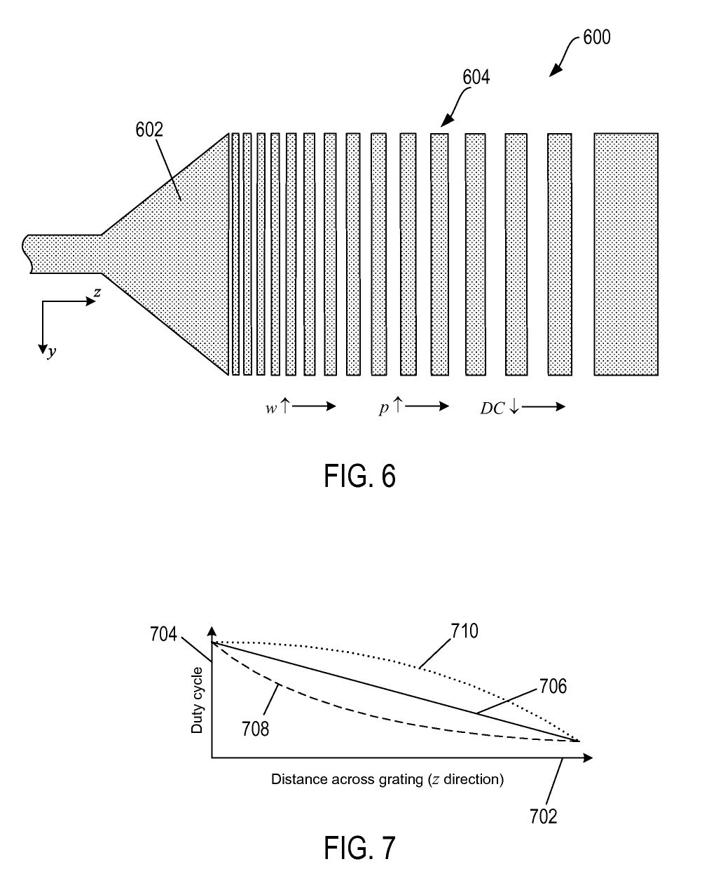

Still other types of suitable non-uniform gratings in which the duty cycle decreases in the z-direction away from the wide edge of the transition region can be accomplished by fabricating the lines so that the line widths and line spacing increase in the z-direction but the line spacing increase is greater than the increase in the line widths. FIG. 6 shows a top-plan view of a tapered transition region 602 and a non-uniform grating 604 of an example grating coupler 600. The grating 604 is composed of a series of approximately parallel lines separated by deep grooves. FIG. 6 reveals the decrease in the duty cycle across the grating 604 in the direction 606 is obtained by an increase in the line widths and the line spacing away from the wide edge 608 in the z-direction, but the increase in line spacing across the grating in the z-direction is greater than the increase in line widths.

FIG. 7 shows a plot of duty cycle versus distance across three types of non-uniform gratings. Horizontal directional arrow 702 represents the distance from the wide edge of a tapered transition region across the grating in the z-direction, and vertical directional arrow 704 represents the duty cycle. Negatively sloped line 706 represents non-uniform gratings with a linearly varying, negatively sloped duty cycle in the z-direction. Dashed line 708 and dotted line 710 represent gratings in which the duty cycle of a non-uniform grating is varied in a non-linear manner across the grating in the z-direction. In particular, dashed line 708 represents an exponential decrease in the duty cycle in the z-direction. For example, lines 708 represents non-uniform gratings in which the widths of the lines are constant or change linearly while the line spacing exponentially increases or the line spacing is constant or changes linearly while the widths of the lines decrease exponentially. Dotted line 710 represents non-uniform gratings in which the decrease in the duty cycle away from the transition region is gradual close the transition region but decreases abruptly the farther from the transition region.

The light output from the non-uniform gratings described above is TM polarized. FIG. 8 shows a top-plan view of the transition region 102 and grating 104 of the grating couplers 100 and 200 and represents TE and TM polarization conventions. As shown in FIG. 8, the transition region 102 spreads out the light carried by the waveguide 106 prior to the light entering the grating 104. By convention, dashed-line, double-headed directional arrow 802 represents TE polarization in which the electric field component of light emitted from the grating 104 would be directed parallel to the lines of the grating 104. Double-headed directional arrow 804 represents TM polarization in which the electric field component of light emitted from the grating 104 is directed perpendicular to the lines of the grating 104. The line thickness t, or depth of the grooves separating the lines, is selected as described above to ensure that of the light emitted from the grating 104 is primarily composed of TM polarized light.

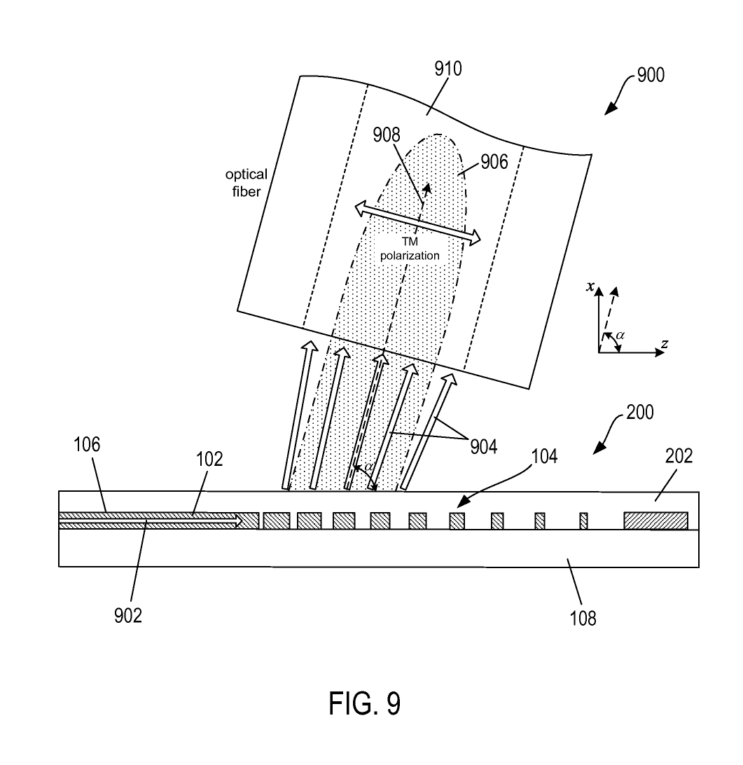

The bulk of the light output from a deep-groove, non-uniform grating of a grating coupler is output with TM polarization and is directed at a non-zero angle above the plane of the grating. FIG. 9 shows a cross-sectional view of the grating coupler 200 and the butt end of an optical fiber 900. Directional arrow 902 represents light transmitted along the waveguide 106 into the transition region 102 where the light spreads out prior to entering the grating 104 and is output from the grating 104 with substantially TM polarization, as described above with reference to FIG. 8. As the light enters and interacts with the grating 104, the grating 104 causes most of the light to be output from the grating near the transition region 102 at a non-perpendicular angle, as represented by directional arrows 904. Shaded region 906 represents the region of space above the grating 104 with the highest concentration of light output from the grating 104. Dashed-line directional arrow 908 represents the direction, α (i.e., α<90 ( ), the highest concentration of light 906 output from the grating 104. As shown in FIG. 9, the end portion of the optical fiber is positioned at approximately the same angle α so that the bulk of the light output from the grating 104 enters the core 910 of the fiber 900.

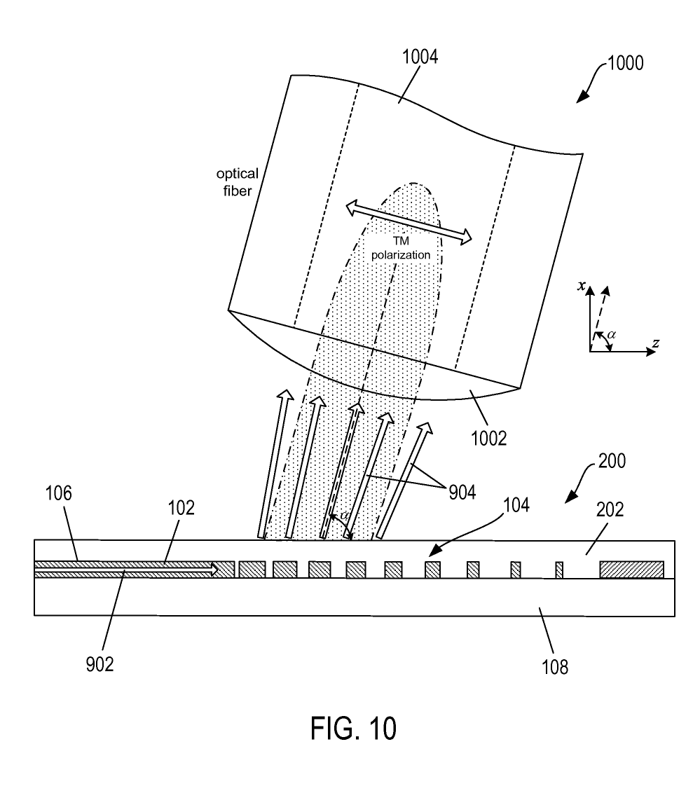

In other embodiments, the end of the fiber can be capped with a plano-convex lens to capture and focus the light output from the grating into the core of the fiber. FIG. 10 shows a cross-sectional view of the grating coupler 200 and the butt end of an optical fiber 1000 capped with a lens 1002. The coupler 200 is operated as described above with reference to FIG. 9, except the lens 1002 captures a larger portion of the light output from the grating 104 than the uncapped end of the fiber 900 and focuses the light into the core 1004 of the fiber 1000.

A grating coupler composed of a transition region and deep-groove, non-uniform, sub-wavelength grating formed in a 250 nm thick Si layer was modeled using MEEP, a finite-difference time-domain (“FDTD”) simulation software package used to model electromagnetic systems (see http://ab-initio.mit.edu/meep/meep-1.1.1.tar.gz). The transition region and deep-groove, non-uniform grating are sandwiched between two oxide layers with the oxide cover layer having a thickness of 1 μm, the lines of the grating having a thickness of 200 nm, and the length of the grating 10 μm. The line spacing ranged from 666-719 nm and the duty cycle varied from 26-36%. Simulation results revealed that the grating couples with wavelengths ranging from approximately 1290 to approximately 1330 nm with an efficiency of approximately 63% and backscattering of approximately 1%.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented for purposes of illustration and description. They are not intended to be exhaustive of or to limit this disclosure to the precise forms described. Obviously, many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

1. A grating coupler including:
a transition region that includes a wide edge and tapers away from the edge toward a waveguide disposed on a substrate; and
a sub-wavelength grating disposed on the substrate adjacent to the edge, wherein the grating includes a series of non-uniformly distributed, approximately parallel lines separated by grooves with a depth to output light from the grating with TM polarization.

2. The coupler of claim 1, wherein the non-uniformly distributed lines further includes the lines have the same width and line spacing between adjacent pairs of lines increases the farther the lines are away from the edge.

3. The coupler of claim 1, wherein the non-uniformly distributed lines further includes the same center-to-center line spacing and the line width decreases the farther the lines are away from the edge.

4. The coupler of claim 1, wherein the non-uniformly distributed lines further includes center-to-center line spacing between adjacent pairs of lines increases the farther the lines are away from the edge and the line width decreases the farther the lines are away from the edge.

5. The coupler of claim 1, wherein the non-uniformly distributed lines further includes center-to-center line spacing between adjacent pairs of lines increases the farther the lines are away from the edge and the line width increases the farther the lines are away from the edge.

6. The coupler of claim 1 includes a cover that covers the transition region and sub-grating and serves as an upper cladding layer.

7. The coupler of claim 1, wherein the non-uniformly distributed lines have a linear duty cycle that decreases away from the edge.

8. The coupler of claim 1, wherein the non-uniformly distributed lines have a non-linear duty cycle that decrease away from the edge.

9. A system including:
a transition region that includes a wide edge and tapers away from the edge toward a waveguide disposed on a substrate;
a sub-wavelength grating composed of a series of non-uniformly distributed, approximately parallel lines disposed on the substrate and separated by grooves with a depth to output light from the grating with TM polarization; and
an optical fiber including a core and cladding layer, the fiber angled so that the bulk of the light output from the grating enters the core.

10. The system of claim 9, includes a focusing lens disposed on a butt end of the optical fiber to focus the light output from the grating into the core.

11. The system of claim 9, wherein the non-uniformly distributed lines further includes the lines have the same width and line spacing between adjacent pairs of lines increases the farther the lines are away from the edge.

12. The system of claim 9, wherein the non-uniformly distributed lines further includes the same center-to-center line spacing and the line width decreases the farther the lines are away from the edge.

13. The system of claim 9, wherein the non-uniformly distributed lines further includes center-to-center line spacing between adjacent pairs of lines increases the farther the lines are away from the edge and the line width decreases the farther the lines are away from the edge.

14. The system of claim 9, wherein the non-uniformly distributed lines further includes center-to-center line spacing between adjacent pairs of lines increases the farther the lines are away from the edge and the line width increases the farther the lines are away from the edge.

15. The system of claim 9, wherein the non-uniformly distributed lines have a duty cycle that decreases away from the edge.
